(19) United States
(12) Patent Application Publication
(10) Pub. No.: US 2022/0082680 A1
(43) Pub. Date: Mar. 17, 2022

(54) VIOLATION DETECTION DEVICE

(71) Applicant: Alan Hanratty, Fort Saskatchewan (CA)

(72) Inventor: Alan Hanratty, Fort Saskatchewan (CA)

(21) Appl. No.: 17/020,706

(22) Filed: Sep. 14, 2020

(51) Int. Cl. G01S 13/58; G01S 13/92; G01S 17/08; G08G 1/054; G08G 1/01; G08G 1/00; G08G 1/017

(52) U.S. Cl. CPC G01S 13/58; G01S 13/92; G01S 17/08; G08G 1/0175; G08G 1/0108; G08G 1/20; G08G 1/054

(57) ABSTRACT

A monitoring device configured to provide regulation monitoring of speed and proximity of vehicles that are adjacent to and/or passing a vehicle that is protected by regulations such as but not limited to an emergency vehicle. The present invention includes a central processing unit having the electronics to store, receive, transmit and manipulate data. The monitoring device includes a plurality of proximity sensors present on the perimeter of the vehicle that measure the distance of nearby vehicles. A speed detection module is mounted to the vehicle and is configured to measure and detect the speed of passing vehicles. A capture module is activated by the central processing unit ensuing a vehicle being detected that has violated the speed and/or proximity set points. A transceiver module will transmit data of a violating vehicle wherein the data includes date, time, license plate picture thereof.

### FIELD OF THE INVENTION

The present invention relates generally to speed and proximity detection devices, more specifically but not by way of limitation, a device operably coupled to an emergency vehicle such as but not limited to an ambulance wherein the device is configured to detect the speed and proximity of passing vehicles and transmit information concerning vehicle that have violated legal requirements.

### BACKGROUND

As is known in the art, thousands of emergency vehicles are deployed on a daily basis in response to various incidents. Vehicles such as but not limited to ambulances are dispatched to roadside accidents to render aid to victims of car accidents. Police cars are also involved in patrolling streets and responding to incidents that results in their need to either travel to a site expeditiously or be parked along a roadside. Other emergency and non emergency vehicles will also be engaged in activities that will require the vehicles to be parked on or adjacent a roadside and as such be exposed to traffic conditions on the road. Another vehicle that has legal requirements for drivers of other vehicles are school buses.

Most areas have laws regarding how drivers of vehicles must operate their vehicle when in the proximity of emergency vehicles, school buses and other essential vehicles such as but not limited to utility/construction vehicles. There are various parameters of these laws that differ from region to region but most are similar in several areas. One area of similarity is the restriction to pass a classified vehicle such as a police car or ambulance when the vehicle is on the roadside. Many laws exist not only about the speed at which drivers may pass but also the proximity allowed when passing. Additionally, for vehicles such as school buses, during loading and unloading of occupants any vehicles traveling proximate thereto must yield. The aforementioned laws are routinely broken and/or disregarded which creates a safety hazard from many individuals.

It is intended within the scope of the present invention to provide a device that is operably coupled to a vehicle wherein the device is configured to provide proximity and speed detection of proximate vehicles and further provide capture and identification thereof upon violation of laws pertaining thereto.

### SUMMARY OF THE INVENTION

It is the object of the present invention to provide a device that is mounted to and operably coupled with a vehicle that is configured to provide detection of speed and proximity of passing vehicles wherein the present invention includes a central processing unit.

Another object of the present invention is to provide a proximity and speed detection device that is operable to an operator of a safety vehicle information concerning passing vehicles wherein the device includes a plurality of proximity detectors mounted on the vehicle.

A further object of the present invention is to provide a device that is mounted to and operably coupled with a vehicle that is configured to provide detection of speed and proximity of passing vehicles wherein the device further includes a speed detection module.

Still another object of the present invention is to provide a proximity and speed detection device that is operable to an operator of a safety vehicle information concerning passing vehicles that further includes a capture module wherein the capture module collects photographic images of proximate vehicles.

An additional object of the present invention is to provide a device that is mounted to and operably coupled with a vehicle that is configured to provide detection of speed and proximity of passing vehicles that further includes a transceiver module wherein the transceiver module is operable to transmit speed and pictorial information of a proximate vehicle to an operator of the device.

Yet a further object of the present invention is to provide a proximity and speed detection device that is operable to an operator of a safety vehicle information concerning passing vehicles wherein the transceiver module is communicably coupled to the central processing unit.

Another object of the present invention is to a provide a device that is mounted to and operably coupled with a vehicle that is configured to provide detection of speed and proximity of passing vehicles that provides automated monitoring once a vehicle equipped therewith is placed adjacent a roadside or other area that has laws pertaining thereto.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an exemplary vehicle equipped with the present invention; and

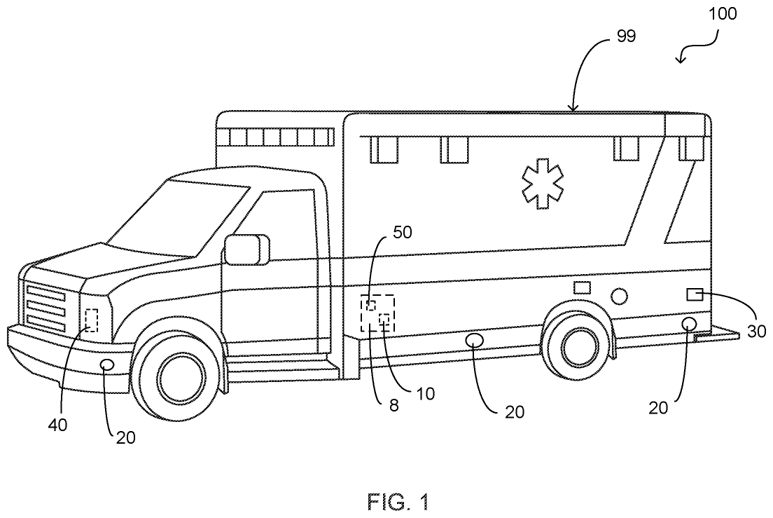

FIG. 2 is a diagrammatic view of an emergency vehicle and adjacent vehicles.

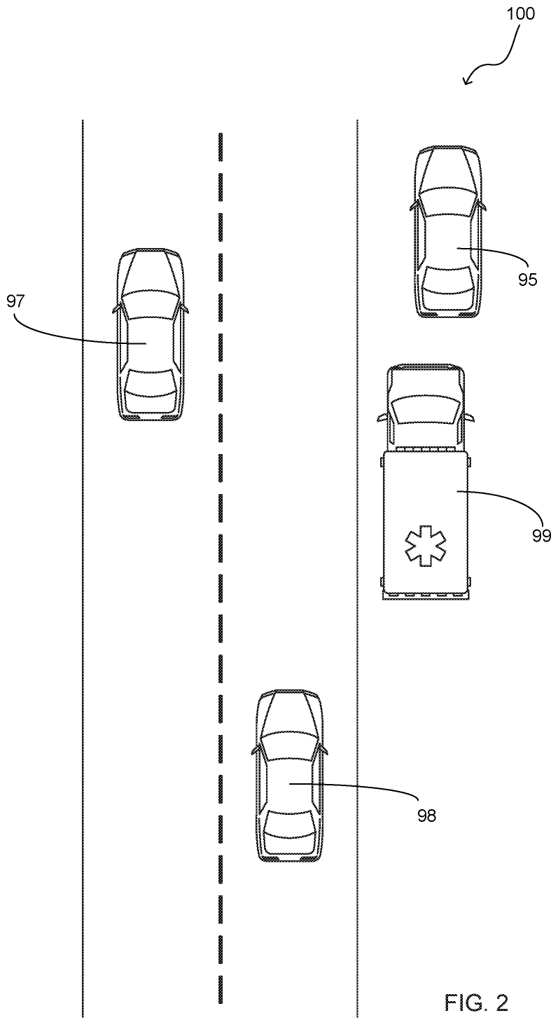

### DETAILED DESCRIPTION

Referring now to the drawings submitted herewith, wherein various elements depicted therein are not necessarily drawn to scale and wherein through the views and figures like elements are referenced with identical reference numerals, there is illustrated a violation detection device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted as a part hereof, the a violation detection device 100 includes a central processing unit 10 wherein the central processing unit 10 is stored in a housing 8. It should be understood within the scope of the present invention that while the central processing unit 10 is illustrated in a particular location on the exemplary vehicle 99 that the central processing unit 10 and the other elements of the a violation detection device 100 discussed herein could be located in various alternate places on the exemplary vehicle 99. While the exemplary vehicle 99 is illustrated as an ambulance, it should be understood within the scope of the present invention that the a violation detection device 100 could be installed on any vehicle wherein the vehicle is subject to the regulations discussed herein. The central processing unit 10 includes electronics configured to receive, store, manipulate and transmit data. It is contemplated within the scope of the present invention that the central processing unit 10 could be electrically coupled to the electrical system of the exemplary vehicle so as to supply the necessary power to operate the central processing unit 10 and the other elements of the present invention.

The a violation detection device 100 further includes a plurality of proximity detectors 20. The proximity detectors 20 in a desired embodiment of the present invention are placed along the perimeter of the exemplary vehicle 99 and are configured to detect the presence of cars 98, 97 and further provide to the central processing unit 10 the distance intermediate the exemplary vehicle 99 and cars 98,97. In a preferred embodiment of the present invention, the proximity detectors 20 utilize infrared detection to be able to monitor the presence and distance of the cars 98,97. Placing the proximity detectors 20 around the perimeter of the exemplary vehicle provides the ability to measure the distance between the exemplary vehicle 99 and cars 98,97 regardless of the side of the road to which the exemplary vehicle 99 has parked to render aid to distressed vehicle 95. While more than one proximity detector 20 has been deployed in the preferred embodiment of the present invention, it is contemplated within the scope of the present invention that the a violation detection device 100 could employ as few as one proximity detector 20. Furthermore, while infrared detection is utilized in the preferred embodiment, it should be understood that alternate technologies could be utilized to provide detection of cars 98, 97.

The a violation detection device 100 further includes a speed detection module 30. The speed detection module 30 is operable to detect, measure and record the speed of the cars 98,97 as the cars 98,97 pass the exemplary vehicle 99. The speed detection module 30 is operably coupled to the central processing unit 10 and is configured to transmit the speed data of the cars 98,97 thereto. It should be further understood within the scope of the present invention that the speed detection module 30 could be located in alternate locations on the exemplary vehicle 99 and furthermore the violation detection device 100 could employ more than one speed detection module 30. In the preferred embodiment of the present invention the speed detection module 30 utilizes radar to detect the speed of the cars 98,97.

A capture module 40 is present and configured to provide a pictorial recording of the cars 98,97 ensuing detection of a violation of speed and/or proximity by the cars 98,97. The capture module 40 utilizes a camera or other convention photographic equipment and it is contemplated within the scope of the present invention that the capture module 40 could capture either still and/or motion pictures of the cars 98,97 wherein the intention is to provide date, time and license plate information along with the photo evidence of the cars 98,97 if they have committed a violation of speed and/or proximity. It should be understood within the scope of the present invention that the a violation detection device 100 could employ more than one capture module 40.

A transceiver module 50 is located in the housing 8 and is operably coupled to the central processing unit 10. The transceiver module 50 is configured to transmit data from the capture module 40 containing the information about the cars 98,97 discussed herein upon the cars 98,97 violation of either a speed or proximity parameter that is programmed into the central processing unit 10. Upon detection of a speed greater than a programmed allowed speed by the speed detection module 30 the central processing unit 10 transmits a signal to the capture module 40 wherein the capture module 40 captures the aforementioned data and send to the central processing unit 10 and is transmitted to an operator of the a violation detection device 100 for processing. The same process as for speed additionally occurs for proximity detection. While in its preferred embodiment the a violation detection device 100 is configured to detect speed and proximity, it is contemplated within the scope of the present invention that the a violation detection device 100 could be configured to detect only speed or proximity if needed to support local regulations. It should be further understood that the a violation detection device 100 is operable to measure for speed and proximity in both conditions when the exemplary vehicle 99 is parked and/or in motion.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A violation detection device operably coupled to an emergency vehicle wherein the violation detection device is configured to provide measurement and detection of parameters of passing vehicles with the violation detection device comprising:
a central processing unit, said central processing unit disposed in a housing mounted on the emergency vehicle, said central processing unit having electronics configured to receive, store, transmit and manipulate data;
at least one proximity detector, said at least one proximity detector being mounted on the emergency vehicle and operably coupled to the central processing unit, said at least one proximity detector configured to measure a distance between the emergency vehicle and the passing vehicles;
at least one capture module, said at least one capture module mounted to the emergency vehicle and operably coupled to the central processing unit, said at least one capture module configured to capture pictorial evidence of a vehicle adjacent to the emergency vehicle immediately subsequent detection of a violation.

2. The violation detection device as recited in claim 1, and further including at least one speed detection module, wherein the speed detection module is mounted to the emergency vehicle and operably coupled to the central processing unit, said speed detection module configured to provide detection of a speed of a vehicle passing the emergency vehicle.

3. The violation detection device as recited in claim 2, and further including a transceiver module, said transceiver module operably coupled to the central processing unit, said transceiver module operable to transmit speed data, proximity data and the pictorial evidence to a remote device.

4. The violation detection device as recited in claim 3, wherein the central processing unit is programmed with proximity regulations and speed regulation for vehicles that are in proximity of the emergency vehicle.

5. The violation detection device as recited in claim 4, wherein upon detection of a speed greater the speed regulation the speed detection module transmits a signal to the central processing unit so as to activate the capture module.

6. The violation detection device as recited in claim 5, wherein upon detection of a proximity closer than the proximity regulation the at least one proximity sensor transmits a signal to the central processing unit so as to activate the capture module.

7. A monitoring device configured to monitor proximity and speed of vehicles adjacent to or in proximity to a vehicle that is protected by regulations regarding speed and proximity of other vehicles in relation thereto wherein the monitoring device comprises:
a central processing unit, said central processing unit disposed in a housing mounted on the emergency vehicle, said central processing unit having electronics configured to receive, store, transmit and manipulate data;
a plurality of proximity sensors, said plurality of proximity sensors being mounted on a perimeter of the vehicle that is protected by regulations, said plurality of proximity sensors operably coupled to the central processing unit, said plurality of proximity sensors configured to measure a distance between the vehicle that is protected by regulations and other vehicles;
at least one speed detection module, wherein the speed detection module is mounted to the vehicle that is protected by regulations and operably coupled to the central processing unit, said at least one speed detection module configured to provide detection of a speed of a vehicle passing the vehicle that is protected by regulations;
at least one capture module, said at least one capture module mounted to the vehicle that is protected by regulations, said at least one capture module being operably coupled to the central processing unit, said at least one capture module configured to capture pictorial evidence of a vehicle adjacent to the vehicle that is protected by regulations immediately subsequent detection of a violation; and
wherein the central processing unit will control the device to activate the at least one capture module in an event that a speed and/or proximity of a vehicle passing the vehicle that is protected by regulations exceeds a programmed legal requirement set point.

8. The monitoring device configured to monitor proximity and speed of vehicles adjacent to or in proximity to a vehicle that is protected by regulations as recited in claim 7, and further including a transceiver module, said transceiver module operably coupled to the central processing unit, said transceiver module operable to transmit speed data, proximity data and the pictorial evidence to a remote device.

9. The monitoring device configured to monitor proximity and speed of vehicles adjacent to or in proximity to a vehicle that is protected by regulations as recited in claim 8, wherein the plurality of proximity sensors utilize infrared to detect proximity of adjacent vehicles.

10. The monitoring device configured to monitor proximity and speed of vehicles adjacent to or in proximity to a vehicle that is protected by regulations as recited in claim 9, wherein the at least one speed detection module employs radar to detect speed of vehicles adjacent to the vehicle that is protected by regulations.
